(19) United States
(12) Patent Application Publication
(10) Pub. No.: US 2026/0102883 A1
(43) Pub. Date: Apr. 16, 2026

(54) WRENCH ASSEMBLY FOR WATER TREATMENT SYSTEM

(71) Applicant: Access Business Group International LLC, Ada, MI (US)

(72) Inventors: Kenny K. Ly, Zeeland, MI (US); Nicholas K. Boyd, Walker, MI (US); Ryan D. Schamper, Grand Haven, MI (US)

(21) Appl. No.: 18/914,647

(22) Filed: Oct. 14, 2024

(51) Int. Cl. B25B 13/50; C02F 1/00; C02F 1/32

(52) U.S. Cl. CPC B25B 13/5008; C02F 1/004; C02F 1/32; C02F 2303/14

(57) ABSTRACT

A wrench assembly to assist in opening and/or closing a containment vessel in a water treatment system. The wrench assembly includes a primary handle configured to rotationally interlock with the main body of the containment vessel and a secondary handle coupled to the primary handle and configured to rotationally interlock with the closure of the containment vessel. The main body includes one or more engagement features configured to interfit with the primary handle. Similarly, the closure includes one or more engagement features configured to interfit with the secondary handle. The primary handle may include a guide portion defining an elongated slot that is configured to receive and guide movement of the secondary handle relative to the primary handle. The secondary handle may snap-fit into place within the slot. The primary handle may be configured to seat against a portion of the main body when properly positioned on the main body.

### BACKGROUND OF THE INVENTION

The present invention relates to water treatment systems, and more particularly to tools used in servicing water treatment systems.

There are a wide range of water treatment systems in common use around the world. Many conventional water treatment systems remove contaminates from water using water treatment components that have a limited life. For example, water treatment systems commonly include one more particulate filters through which water is passed to remove a range of suspended solid, such as dirt, sand, silt, clay and organic matter. Some additionally or alternatively includes activated carbon filters that are capable of treating water through adsorption. Still other water treatment systems include treatment components, such as UV light sources, that are intended to kill microorganisms that might be present in the water, such as bacteria, viruses, protozoa, algae and fungi. These are just a few examples of common water treatment components with many other types of components used in different water treatment systems.

Many of the most common water treatment components have a limited life and must be replaced or otherwise serviced (e.g. cleaned or regenerated) on a periodic basis. To make it easier to service water treatment components, they are commonly situated in a tank assembly, reactor assembly, pressure vessel or other containment vessel that is readily accessible to the user of the water treatment system. Typical containment vessels provide a leaktight enclosure in which the water to be treated is presented to the water treatment component(s). For example, a containment vessel may house a particulate filter that must be periodically replaced and an activated carbon block filter that must be periodically replaced or periodically regenerated. The typical containment vessel includes a removable closure that can be readily removed to gain access to the interior of the containment vessel and the water treatment system components housed therein.

While some containment vessels are specifically designed to be opened and closed by hand, conventional hand-operated closure arrangements suffer from a number of issues. One issue is that it can be difficult to provide a closure arrangement that does not leak when closed only by hand. Leaks are even more likely when the user is disabled or lacks the strength to tighten the closure as designed. Another issue is that users often find it hard to open the closure arrangement by hand. Again, this issue is amplified when the user is disabled or is of limited strength. To illustrate, many containment vessels utilize a threaded closure arrangement that is installed and removed through manual rotation of the closure. These closure arrangements often include a seal that is compressed as the closure is tightened. If the closure is not adequately tightened, the seal may leak. Further, it can be difficult to loosen the closure after it has been tightened as required to provide a leaktight seal. Given the issues presented by hand-operated closure arrangements, some containment vessels are designed to be opened and closed using common tools, such as wrenches and pliers. However, given the size, shape and configuration of many conventional containment vessels, common tools are not well-suited for this purpose.

In view of the foregoing, there is an ongoing and unmet need for a simple and effective tool that better facilitates opening and/or closing of a containment vessel in a water treatment system.

### SUMMARY OF THE INVENTION

A wrench assembly is provided to facilitate servicing of components in a water treatment system, wherein the wrench assembly includes a primary wrench handle and a secondary wrench handle that are mechanically interfitted in an arrangement that guides the primary and secondary handles through a range of motion relative to one another. In one embodiment, the primary wrench includes a guide portion defining an elongated slot through which the secondary handle is fitted to at least temporarily join the two handles. The secondary handle is capable of moving along the slot in the direction required to service the water treatment system. The slot is configured to define a range of motion between the primary handle and the secondary handle.

In one embodiment, the wrench assembly is configured to facilitate opening and/or closing of a containment vessel (e.g. tank assembly, pressure vessel or other similar structure) with a main body configured to receive at least one water treatment component and a closure that is rotatably fitted to the main body to close the containment vessel. In this embodiment, the primary handle includes a jaw portion configured to mechanically interfit with the main body and an arm portion that extends from the jaw portion to provide a lever arm. Similarly, the secondary handle includes a jaw portion configured to mechanically interfit with the closure and an arm portion that extends from the jaw portion to provide a lever arm.

In one embodiment, the jaw portion of the primary handle includes an inner edge configured to mechanically interlock with the main body of the containment vessel. In one embodiment, the jaw portion is configured to extend around and correspond with at least a portion of the outer of the surface main body. When the main body has a circumferential shape, the jaw portion of the primary handle may have a corresponding circumferential shape forming a generally circular ring-like structure that extends around the full circumference of the main body of the containment vessel. In alternative embodiments, the jaw portion may extend about only a portion of the main body.

In one embodiment, the jaw portion of the secondary handle includes an inner edge configured to mechanically interlock with the closure of the containment vessel. In one embodiment, the jaw portion is configured to extend around and correspond with at least a portion of the outer surface of the closure. When the closure has a circumferential shape, the jaw portion of the secondary handle may have an arcuate shape that corresponds with and extends about a portion of the circumference of the closure. For example, the jaw portion may extend around about a 90 degrees portion of the closure. In alternative embodiments, the jaw portion of the secondary handle may extend about more or less of the circumference of the closure.

In one embodiment, the main body of the containment vessel includes one or more engagement features and the jaw portion of the primary handle includes mating features configured to interlock with the engagement features when the primary handle is installed on the main body. The engagement features may be one or more ribs extending from the outer surface of the main body. The engagement features may include a plurality of ribs arranged in a radially symmetrically pattern about the main body.

In one embodiment, the closure of the containment vessel includes at least one engagement feature and the jaw portion of the secondary handle includes at least one mating feature configured to mechanically interlock with the engagement feature when installed. The engagement feature may be a rib extending from the outer surface of the closure. The engagement rib may extend beyond the outer circumference of the main body. In alternative embodiments, the number and arrangement of engagement features may vary.

In one embodiment, the wrench assembly is configured to mechanically seat against a portion of the containment vessel when properly positioned for use. The main body may include a mouth that is surrounded by an outwardly extending peripheral lip or other similar structure against which the wrench assembly can seat. In one embodiment, the primary handle is configured to seat against the main body. To provide this arrangement, the jaw portion of the primary handle may be configured to abut or otherwise engage the peripheral lip when the wrench assembly is in the correct position to manipulate the containment vessel. For example, the jaw portion may include an inner circumferential lip that is smaller in diameter than the peripheral lip. The wrench assembly may be positioned for use by fitting it over the bottom of the main body and raising it along the main body until the inner circumferential lip comes into contact with the peripheral lip.

In one embodiment, the primary handle includes a guide portion that retains the secondary handle in a position that allows the secondary handle to engage with the closure of the containment vessel when the wrench assembly is properly positioned for use. In one embodiment, the jaw portion includes a raised shoulder that extends upwardly relative to the inner circumferential lip. The raised shoulder may have an inner diameter that is larger than the outer diameter of the peripheral lip so that the shoulder extends above the peripheral lip when the wrench the circumferential lip is engaged with the peripheral lip. In this embodiment, the raised shoulder forms the guide portion and defines the extended slot.

The wrench assembly of the present invention provides a simply and effective tool that facilitates opening and/or closing of a containment vessel, such as a tank assembly, UV chamber or pressure vessel, containing replaceable water treatment components, such as filters and UV light sources. The wrench assembly include two wrench parts that are capable of being coupled together for use. The guide portion can be configured not only to join the primary and secondary handle, but also to shepherd relative movement of the two handles. If desired, the two handles may be configured to snap together to at least temporarily hold them together. Further, the primary handle can be configured to mechanically seat against a portion of the containment vessel to help ensure proper positioning of the wrench assembly on the containment vessel. The primary and secondary handle may be configured to interlock with essentially any engagement features that may be provided on the main body and the closure of the containment vessel. The number and location of engagement features can be varied to accommodate containment vessel parts of different designs and configurations. Longitudinally extending ribs provide simple and effective engagement features that allow the wrench assembly to be easily fitted to and removed from the containment vessel.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a wrench assembly and containment vessel combination in accordance with an embodiment of the present invention.

FIG. 2 is a perspective view of the wrench assembly.

FIG. 3 is an exploded perspective view of the containment vessel.

FIG. 4 is a bottom perspective view of the wrench assembly fitted to the containment vessel.

FIG. 5 is an exploded perspective view of the closure.

FIG. 6 is a perspective view showing the primary handle separate from the secondary handle.

FIG. 7 is an enlarge view of a portion of the wrench assembly seated on the containment vessel showing the snap-fit arrangement between the primary handle and secondary handle.

FIG. 8 is a top plan view of the primary handle.

FIG. 9 is a rear view of the primary handle.

FIG. 10 is a top plan view of the secondary handle.

FIG. 11 is a rear side view of the secondary handle.

FIG. 12 is a perspective view of a first alternative wrench assembly.

FIG. 13 is a perspective view of a second alternative wrench assembly.

FIG. 14 is a perspective view of another alternative secondary handle.

FIG. 15 is a perspective view of yet another alternative secondary handle.

### DETAILED DESCRIPTION OF THE CURRENT EMBODIMENTS

### Overview

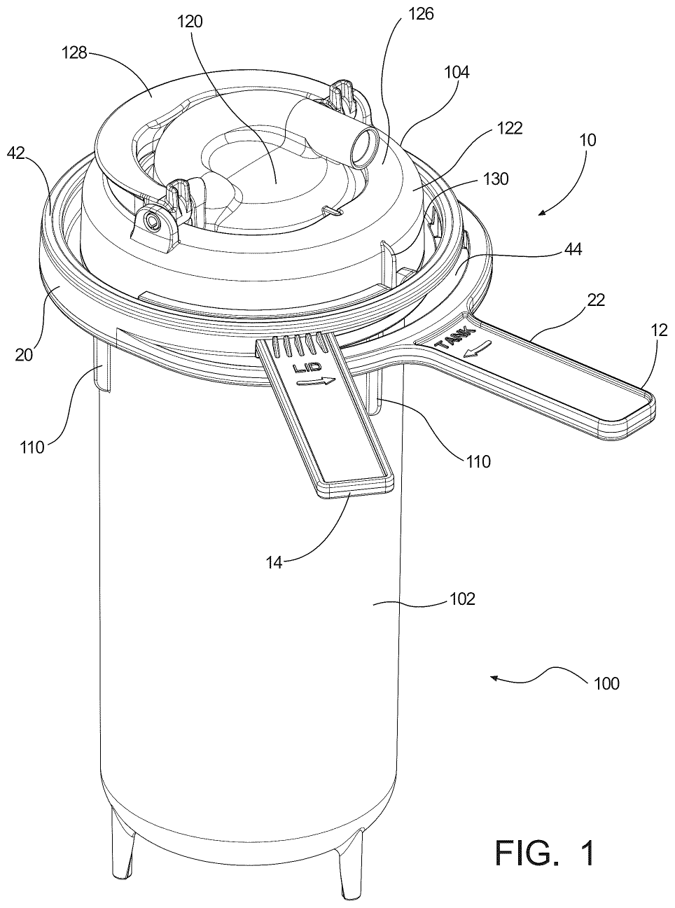

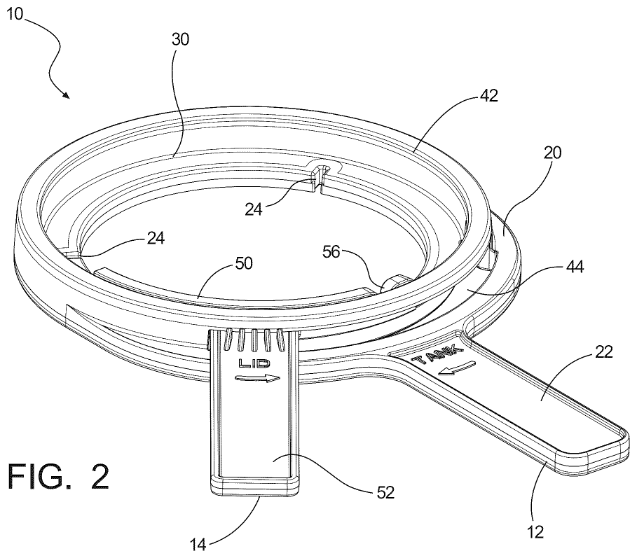

A wrench assembly and containment vessel in accordance with an embodiment of the present invention are shown in FIG. 1. The wrench assembly 10 generally includes a primary handle 12 and secondary handle 14 that are coupled together for use and are configured to provide a mechanical advantage (e.g. leverage) in opening and/or closing a containment vessel of a water treatment system (not shown). The illustrated wrench assembly 10 is configured for use in servicing the containment vessel 100, though the wrench assembly 10 may be differently configured to service a wide range of different containment vessels. The containment vessel 100 generally includes a main body 102 that is closed by a closure 104. For example, the closure 104 and the main body 102 may be threaded so that the closure 104 can be threadedly onto the main body 102 to enclose water treatment components (not shown) disposed within the containment vessel 100. In use, the wrench assembly 10 is installed on the containment vessel 100 with the primary handle 12 engaged with the main body 102 and the secondary handle 14 engaged with the closure 104. Once installed, the primary handle 12 and secondary handle 14 can be moved relative to one another to rotate the closure 104 relative to the main body 102 to either open or close the containment vessel 100.

### Description of Illustrated Embodiments

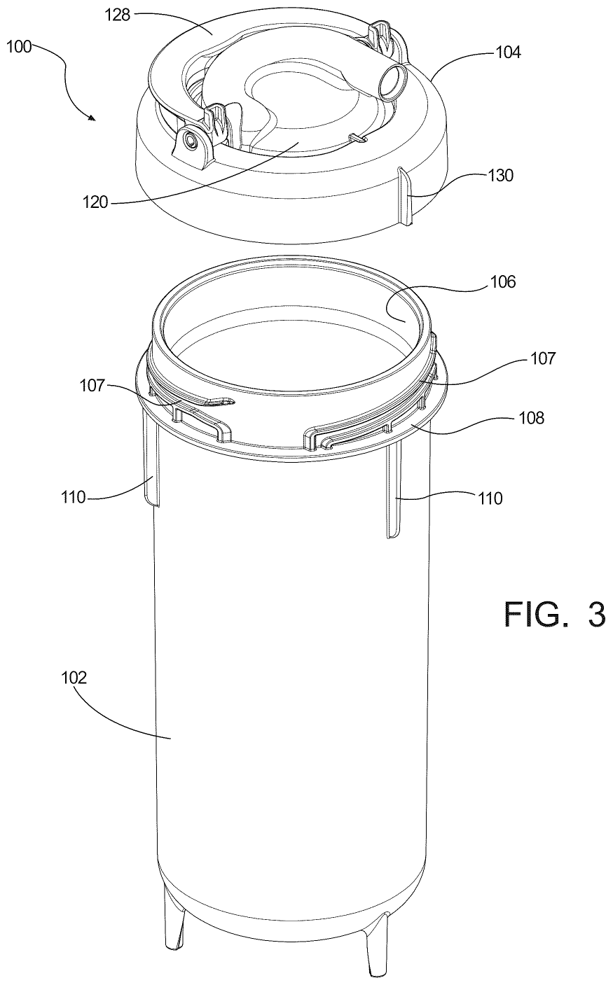

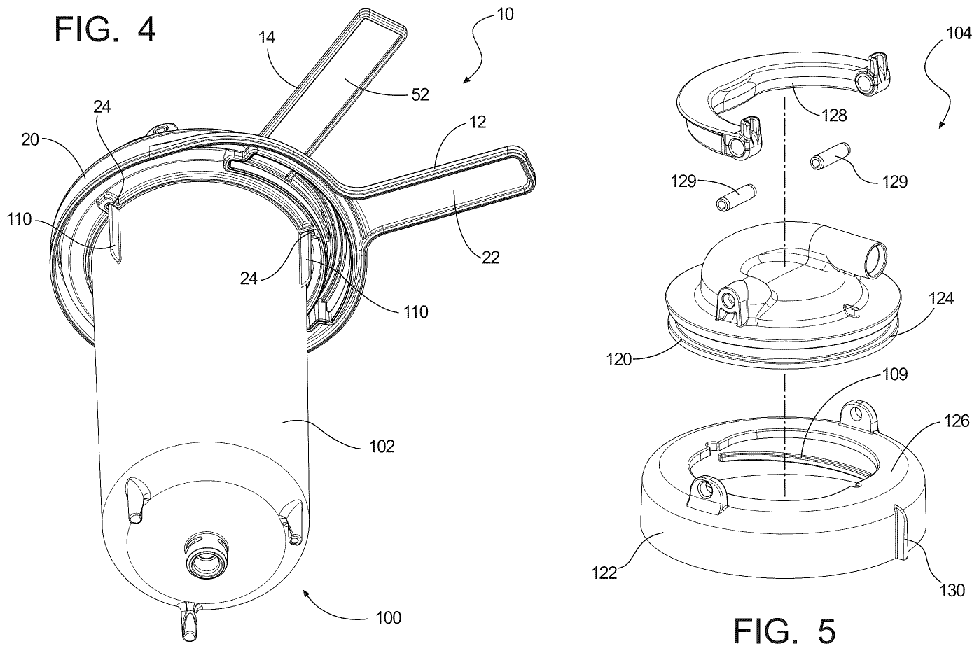

As noted above, the wrench assembly 10 of FIG. 1 is configured to service the containment vessel 100 (See FIGS. 1, 3 and 4). The illustrated containment vessel 100 includes a main body 102 and a closure 104 that cooperatively define an enclosed space to contain one or more water treatment components. For example, in the illustrated embodiment, the containment vessel 100 is a tank assembly that holds one or more water filters (not shown). As shown, the main body 102 of the illustrated containment vessel 100 is a tall cylindrical well that terminates at an open upper end in a mouth 106. While the cross-sectional shape of the main body 102 is circular in the illustrated embodiment may vary from application to application as desired. In this embodiment, the mouth 106 is situated at the top of the main body 102, but it could be located elsewhere in alternative embodiments, such as on the bottom or on a side of the main body 106. In alternative embodiments, the main body may include more than one opening (or more than one mouth) that is closed by more than one closure. For example, the top and bottom of the main body may include removable closures. In such applications, the wrench assembly may be configured to open/close one or more of the closures.

In the illustrated embodiment, the closure 104 is configured to secure to the main body 102 over the mouth 106 by a threaded connection. To that end, the main body 102 includes one or more external threads 107 that extend around the main body 102 near the mouth 106. The external threads are configured to mate with corresponding internal threads 109 on the closure 104. A peripheral lip 108 extends outwardly from the main body 102 adjacent to the threads 108 to provide a structure against which to seat the closure 104 when it is fully threaded onto the main body 102. Although the main body 102 and closure 104 are joined by a threaded connection in the illustrated embodiment, alternative attachment structure may be incorporated in alternative embodiments. For example, the main body and the closure may be joined using a bayonet fitting, such as a quarter-turn bayonet fitting. The size, shape and configuration of the containment vessel 100 may vary from application to application as desired to, for example, accommodate water treatment components of different sizes and shapes.

To facilitate interaction with the wrench assembly 10, the main body 102 includes one or more engagement features that provide a structure for mechanically coupling the primary handle 12 to the main body 102. In the illustrated embodiment, the main body 102 includes a plurality of longitudinally extending ribs 110 that protrude from the outer surface of the main body 102 adjacent to the peripheral lip 108 to function as engagement features. More specifically, the illustrated main body 102 includes three generally identical ribs 110 that are spaced equally about the circumference of the main body 102. Two of the three ribs 110 are visible in FIGS. 1, 3 and 4 and the third is positioned on the back side of the main body 102 where it is hidden from view. The number, size, shape and arrangement of engagement features may vary from application to application.

As noted above, the containment vessel 100 includes a closure 104 that closes the mouth 106 of the main body 102. Although the containment vessel 100 may include essentially any closure 104 capable of closing the main body 102, the closure 104 of the illustrated embodiment generally includes a lid 120 that is fitted into the mouth 106 of the main body 102 and a locking ring 122 that secures the lid 120 in place within the mouth 106. More specifically, the illustrated lid 120 is a disk-shaped component that fits closely within the mouth 106. The lid 120 includes an annular seal 124 that engages to interior of the main body 102 to provide a leaktight seal with the main body 102. The locking ring 122 is configured to fit over the lid 120 and threadedly secure to the main body 102. The locking ring 122 includes internal threads 109 configured to mate with the external threads 107 on the main body 102. The locking ring 122 includes an inwardly extending annular ledge 126 that is positioned to engage the top surface of the lid 120 when the locking ring 122 is properly seated on the main body 102. In this way, the locking ring 122 holds the lid 120 in place within the mouth 106. In the illustrated embodiment, the locking ring 122 also includes a pivoting handle 128 that is attached by pins 129 and can be used to assist in handling the containment vessel 100. To facilitate interaction with the wrench assembly 10, the closure 104 (and more specifically, the locking ring 122) includes one or more engagement features that provide a structure for mechanically coupling the secondary handle 14 to the closure 104. In the illustrated embodiment, the locking ring 122 includes a single rib 130 that protrude from the outer surface of the locking ring 122 in a position where it will be near the peripheral lip 108 when the locking ring 122 is installed on the main body 102. To facilitate use of the wrench assembly 10, the threads on the main body 102 and the locking ring 122 may be configured to ensure that, when properly installed, the locking ring rib 130 is positioned at a desired location relative to ribs 110 on the main body 102. For example, the main body 102 may include three radially symmetric thread segments corresponding with the three ribs 110 and the locking ring 122 may include three radially symmetric thread segments. This arrangement allows the locking ring 122 to thread onto the main body 102 in three different rotational positions that result in the locking ring rib 130 being positioned relative to a different one of the three main body ribs 110. The number, size, shape and arrangement of engagement features on the closure may vary from application to application.

The size, shape and configuration of the closure may vary from application to application. For example, the closure may, in some embodiments, be a one-piece shallow bowl-shaped structure that is threadedly fitted to the external threads on the main body 102 to close the mouth 106.

When using the illustrated embodiment, the wrench assembly 10 is fitted onto the containment vessel 100 with the primary handle 12 rotationally interlocked with the main body 102 of the containment vessel 100 and the secondary handle 14 rotationally interlocked with the closure 104. For purposes of this disclosure, the phrase “rotationally interlocked” is used to refer to an engagement in which movement of the primary handle or the secondary handle results in corresponding rotational movement of the main body 102 or the closure 104, respectively (e.g. the locking ring 122). Once installed on the containment vessel 100, the primary handle 12 and the secondary handle 14 can be moved relative to one another to rotate the closure 104 relative to the main body 102, thereby opening or closing the containment vessel 100. The wrench assembly 10 may be particularly useful in providing a mechanical advantage to assist in final tightening and initial loosening the closure 104.

As discussed above, the wrench assembly 10 generally includes a primary handle 12 and a secondary handle 14 that a user can use in cooperation to open and/or close the containment vessel 100. The primary handle 12 and the secondary 14 are configured to interfit to facilitate their installation on the containment vessel 100 and their use in combination. The wrench assembly 10 is particularly useful in opening the containment vessel 100 to service water treatment components (e.g. replacing or performing maintenance on a water treatment component) that might be housed in the containment vessel 100 and in closing the containment vessel 100 after servicing is complete.

The wrench assembly 10 generally includes a primary handle 12 having a jaw portion 20 configured to mechanically interfit with the main body 102 of the containment vessel 100 and an arm portion 22 extending from the jaw portion 20 to provide a handle for operating the wrench assembly 10. In the illustrated embodiment, the jaw portion 20 of the primary handle 12 is configured to extend around and correspond with at least a portion of the outer surface of the main body 102. More specifically, the jaw portion 20 is configured with mating features in the form of notches 24 that mechanically interlock with the ribs 110 on the main body 102 of the containment vessel 100. As shown, the primary handle 12 includes three notches 24 arranged in a radially symmetric pattern that mirrors the pattern of the ribs 110 so that the three ribs 110 can be simultaneously fitted into the three notches 24. Although the mating features of the illustrated primary handle 12 are notches 24, the mating features may, in alternative embodiments, vary in number, size, shape and configuration to rotationally interlock with the engagement features on the main body 102.

In the illustrated embodiment, the main body 102 is generally circular in cross section and the jaw portion 20 has a generally circular ring-like structure that corresponds with and extends around the full circumference of the main body 102. In alternative embodiments, the jaw portion 20 may extend about only a portion of the main body 102, such as approximately ¾, ½ or ¼ of the circumference of the main body 102. In other alternative embodiments, the jaw portion 20 may be configured to interfit with the engagement features on the main body 102 without otherwise closely following the outer shape of the main body 102.

To help properly seat the wrench assembly 10 on the containment vessel 100, the illustrated jaw portion 20 of the primary handle 12 is configured to abut the peripheral lip 108 of the main body 102 when in the correct position to manipulate the closure 104. More specifically, the jaw portion 20 of the illustrated primary handle 12 includes an inner circumferential lip 30 having an inner diameter that is smaller than diameter the outer diameter of the peripheral lip 108. The wrench assembly 10 is positioned for use by fitting the jaw portion 20 over the bottom of the main body 102 and then raising the wrench assembly 10 upwardly along the main body 102 until the inner circumferential lip 30 comes into contact with the peripheral lip 108. In the illustrated embodiment, the inner circumferential lip 30 extends continuously around the circumference of the main body 102, but it need not be continuous and may, for example, be replaced in alternative embodiments with a discontinuous lip 108 or other structure capable of interfacing with the peripheral lip 108 or other structure on the containment vessel 100.

In the illustrated embodiment, the primary handle 12 includes a guide portion that receives the secondary handle 14 in a position that allows the secondary handle 14 to engage with the closure 104 of the containment vessel 100 when the wrench assembly 10 is properly positioned for use. In illustrated embodiment, the guide portion is formed by a raised shoulder 42 that extends upwardly relative to the inner circumferential lip 30. The raised shoulder 42 has an inner diameter that is larger than the outer diameter of the peripheral lip 108 so that the shoulder 42 extends above the peripheral lip 108 when the wrench assembly 10 is properly seated against the peripheral lip 108. As perhaps best shown in FIG. 9, the raised shoulder 42 defines an elongated slot 44 that extends in a radial direction. The slot 44 is of sufficient width to receive the arm 52 of the secondary handle 14 and of sufficient length to allow the desired range of motion of the secondary handle 14 relative to the primary handle 12. In the illustrated embodiment, the elongated slot 44 extends about approximately 90 degrees of the circumference of the jaw portion 24. The width and length of the slot 44 may vary from application to application. In the illustrated embodiment, the secondary handle 14 has a width that is configured to closely match with the width of the slot 44. If desired, the secondary handle 14 may be configured to snap-fit or otherwise interlock in the fully seated position within the slot 44 in such a way as to resist removal from the slot 44 while simultaneously allowing the secondary handle 14 to move along the length of the slot 44 as needed to rotate the closure 104 relative to the main body 102. For example, in the illustrated embodiment, the arm portion 52 of the secondary handle 14 includes snap features that are forced through the slot 44 and retained in place within the slot 44 by an interference fit. More specifically, and as perhaps best shown in FIG. 7, the arm portion 52 of the secondary handle may include a plurality of triangular locking ribs 46 (in this case, five locking ribs) that allow the secondary handle 14 to snap fit into place within the guide portion of the primary handle 12. The angled surface of each rib 46 facilitates insertion through the slot 44 and, once fully inserted, the flat surface of each rib 46 resists its removal. The number, size, shape and configuration of snap features may vary from application to application, for example, to selectively control various factors, such as the amount of force required to install and/or remove the secondary handle 14 from the guide portion of the primary handle 12. In alternative applications, the secondary handle 14 may be provided without any type of interlocking/interfitting features so that the secondary handle 14 can be easily inserted into and removed from the guide portion of the primary handle 12.

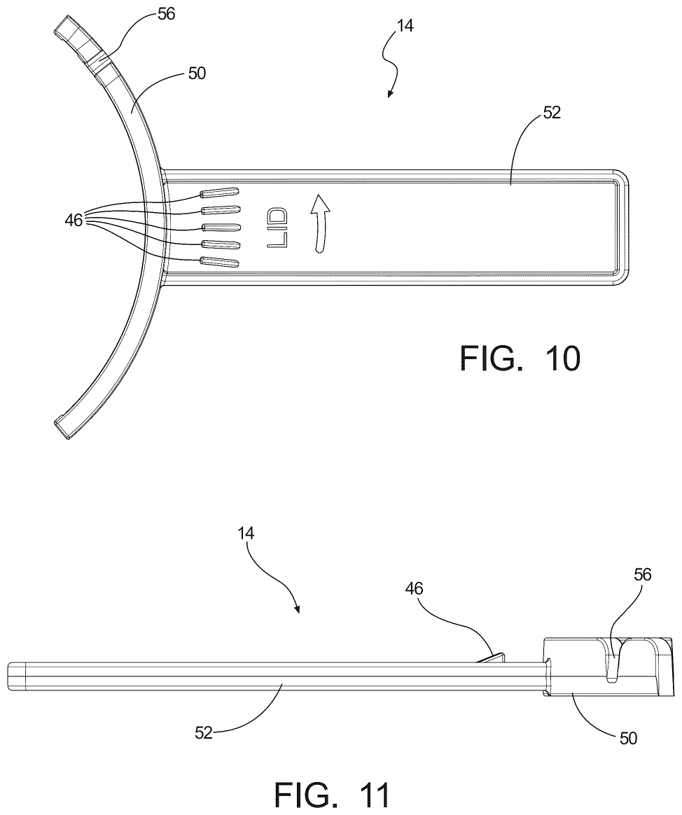

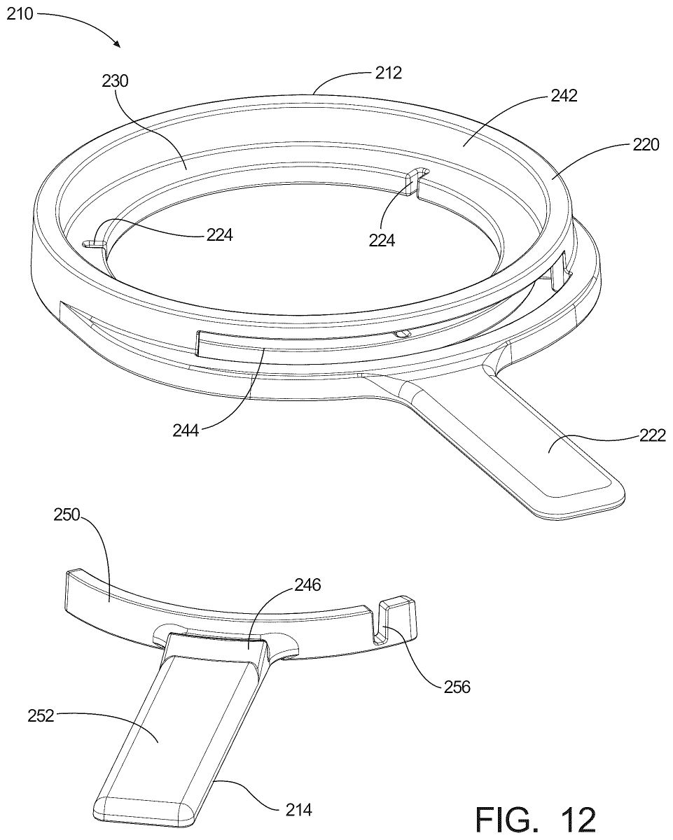

Like the primary handle 12, the secondary handle 14 includes a jaw portion 50 configured to mechanically interfit with the closure 104 and an arm portion 52 that extends from the jaw portion 50 to function as a handle for manipulating the wrench assembly 10 (See FIGS. 10 and 11). In the illustrated embodiment, the jaw portion 50 of the secondary handle 14 includes an arcuate portion configured to mechanically interface with an engagement feature on the closure 104. As shown, the jaw portion 50 is configured to extend around and correspond with at least a portion of the outer surface of the closure 104. For example, the jaw portion 50 may extend around about a 90 degrees portion of the closure 104. In alternative embodiments, the jaw portion of the secondary handle may extend about more or less of the circumference of the closure 104.

In the illustrated embodiment, the closure 104 of the containment vessel 100 includes an engagement feature in the form of a single rib 130. To interface with the rib 130, the jaw portion 50 of the secondary handle 14 includes at least one notch 56 configured to mechanically interlock with the rib 130 when the wrench assembly 10 is installed on the containment vessel 100. In alternative embodiments, the number, size, shape and arrangement of engagement features on the closure and on the secondary handle may vary. use of wrench assembly.

In use, the primary handle 12 and the secondary handle 14 are joined by fitting the secondary handle 14 through the slot 44 in the guide portion of the primary handle 12. The secondary handle 14 may be configured to snap-fit in place by forcing triangular ribs 46 through the slot 44. The assembled wrench assembly 10 is then fitted up over the containment vessel 100 from the bottom and raised upwardly along the main body 102 of the containment vessel 100. As the wrench assembly 10 is raised, the mating features (e.g. notches 24) in the jaw portion 20 are aligned within and fitted over the engagement features (e.g. ribs 110) on the main body 102. In this embodiment, the wrench assembly 10 is raised along the main body 102 until the wrench assembly 10 seats against the main body 102. As shown, the primary handle 12 seats against the peripheral lip 108 and, more specifically, the top surface of the inner circumferential lip 30 engages the undersurface of the peripheral lip 108. As the wrench assembly 10 approaches the seated position, the secondary handle 14 is positioned so that the mating feature (e.g. notch 56) on the secondary handle 14 aligns with and is fitted over the engagement feature (e.g. rib 130) on the locking ring 122. It should be noted that the position of the secondary handle 14 within the slot 44 of the primary handle 12 may be selected based on the desired direction of operation. For example, when it is desirable to open the containment vessel 100, the secondary handle 14 can be located toward the end of the slot 44 that allows the secondary handle 14 to rotate the locking ring 122 in the counterclockwise direction. And, when it is desirable to use the wrench assembly 10 to close/tighten the containment vessel 100, the secondary handle 14 can be located toward the opposite end of the slot 44 to allow the secondary handle 14 to rotate the locking ring 122 in the clockwise direction.

Once the wrench assembly 10 is properly installed on the containment vessel 100, the primary handle 12 is rotationally interlocked with the main body 102 and the secondary handle 14 is rotationally interlocked with the locking ring 122. The closure 104 can then be loosened or tightened by manually moving the primary handle 12 and the secondary handle 14 relative to one another. For example, an installed closure 104 can be loosened for removal by grasping the arm portion 22 of the primary handle 12 with one hand and the arm portion 52 of the secondary handle 14 with the other, and then moving the secondary handle 14 along the slot 44 in a direction that rotates the closure 104 in the counterclockwise direction. Alternatively, the closure 104 can be tightened onto the main body 102 by moving the secondary handle 14 along the slot 44 in a direction that rotates the closure 104 in the clockwise direction. While the wrench assembly 10 is particularly well-suited for use in initially loosening the closure 104 and applying a final tightening to the closure 104, the wrench assembly 10 can be repositioned to allow the wrench assembly 10 to further move the closure 104 in either clockwise or counterclockwise direction.

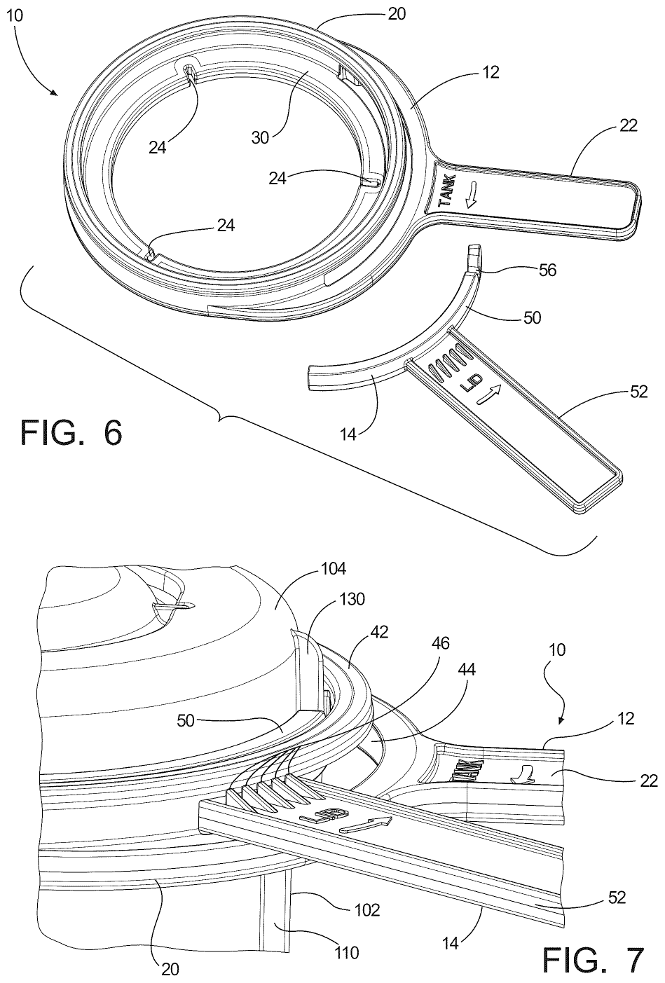

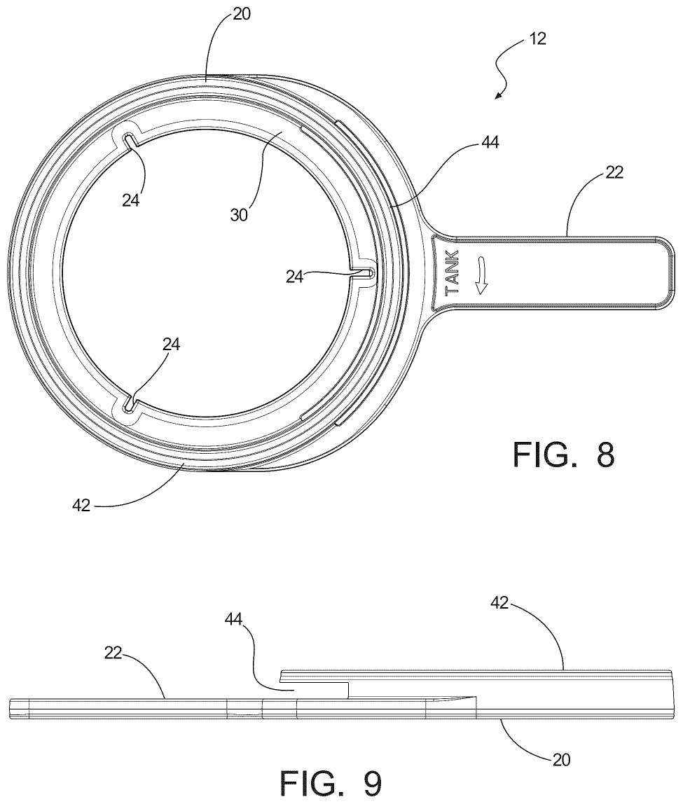

It should be noted that in some applications, the wrench assembly 10 may be used only to tighten or only to loosen the closure 104 on the main body 102. For example, in the illustrated embodiment, the wrench assembly 10 may, in some instances, be used only to loosen the closure 104. In this embodiment, the primary handle 12 and the secondary handle 14 includes graphic elements, such as arrows, and text, such as words, that assist in use of the wrench assembly 10. As shown in FIG. 6, the primary handle 12 includes the word “TANK” (indicating that the primary handle 12 is configured to be fitted to the main body 102 (also known as the tank of the containment vessel) and an arrow indicating the direction the primary handle 12 should be moved to loosen the closure 104. And the secondary handle 14 includes the word “LID” (indicating that the secondary handle 14 is configured to be fitted to the closure 104 (also known as the lid of the containment vessel) and an arrow indicating the direction the secondary handle 14 should be moved to loosen the closure 104.

### Illustrated Alternative Embodiments

As discussed above, the design and configuration of the primary and secondary handles may vary from application to application. For example, FIG. 12 shows an alternative wrench assembly 210. In this embodiment, the primary handle 212 and the secondary handle 214 are generally identical to primary handle 12 and secondary handle 14, except that secondary handle 214 includes a differ type of snap-fit configuration. More specifically, the secondary handle 214 of this embodiment includes a single wide triangular protrusion that is snap-fitted with the slot 44. Further, the primary handle 212 and the secondary handle 214 of this embodiment are lacking the graphic content that may help a user operate the wrench. Except as expressly shown or described, wrench assembly 210 is generally identical to wrench assembly 10 and FIG. 12 includes reference numbers that correlate with those used for wrench assembly 10, except that they are preceded by a “2”(e.g. primary handle 212 instead of 12 and secondary handle 214 instead of 14).

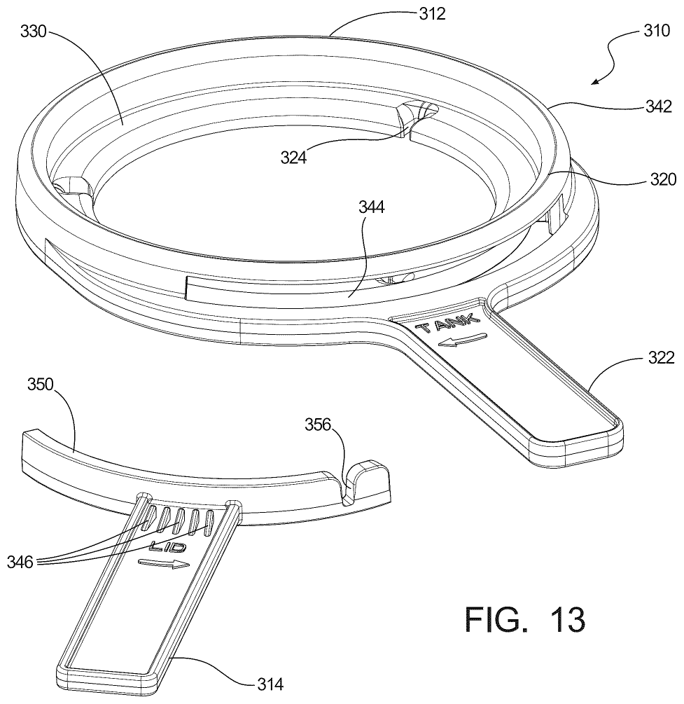

FIG. 13 shows another alternative embodiment of the wrench assembly 310. In this embodiment, the primary handle 312 and the secondary handle 314 are generally identical to primary handle 12 and secondary handle 14, except that primary handle 312 includes an elongated slot of a different configuration and the secondary handle 314 includes a jaw portion of a different configuration. As shown, the primary handle 312 of this embodiment includes a shorter elongated slot 344. For example, primary handle 312 includes a slot 344 that extends through about 60 degrees, while the primary handle 12 includes a slot 44 that extends through about 100 degrees. The lengths of these slot 44, 344 are merely exemplary and the slot length may vary from application to application. Referring again to FIG. 13, the secondary handle 314 has a jaw portion that extends through about 145 degrees, while the secondary handle 14 has a jaw portion that extends through about 95 degrees. The lengths of these jaw portions are merely exemplary and may vary from application to application. Except as expressly shown or described, wrench assembly 310 is generally identical to wrench assembly 10 and FIG. 13 includes reference numbers that correlate with those used for wrench assembly 10, except that they are preceded by a “3” (e.g. primary handle 312 instead of 12 and secondary handle 314 instead of 14).

FIG. 14 shows an alternative embodiment of the secondary handle 414 in which the jaw portion does not include a slot. In this embodiment, the end 456 of the jaw portion 450 is the mating feature. In use, the secondary handle 414 is positioned so that the end 456 of the jaw portion 450 that faces in the direction of desired movement engages with the closure (e.g. the rib 130) so that further movement of the secondary handle 414 in that direction causes rotation of the closure. In this embodiment, the jaw portion 450 of the secondary handle 414 is also shorter than the jaw portion 50 of the secondary handle 14. For example, in this embodiment, the end 456 of the jaw portion 450 of the secondary handle 414 terminates in approximate correspondence with the notch 456 in jaw portion 450 of secondary handle 414. Except as expressly shown or described, secondary handle 414 is generally identical to secondary handle 14 and FIG. 14 includes reference numbers that correlate with those used for secondary handle 14, except that they are preceded by a “4”(e.g. secondary handle 414 instead of 14 and jaw portion 450 instead of 50).

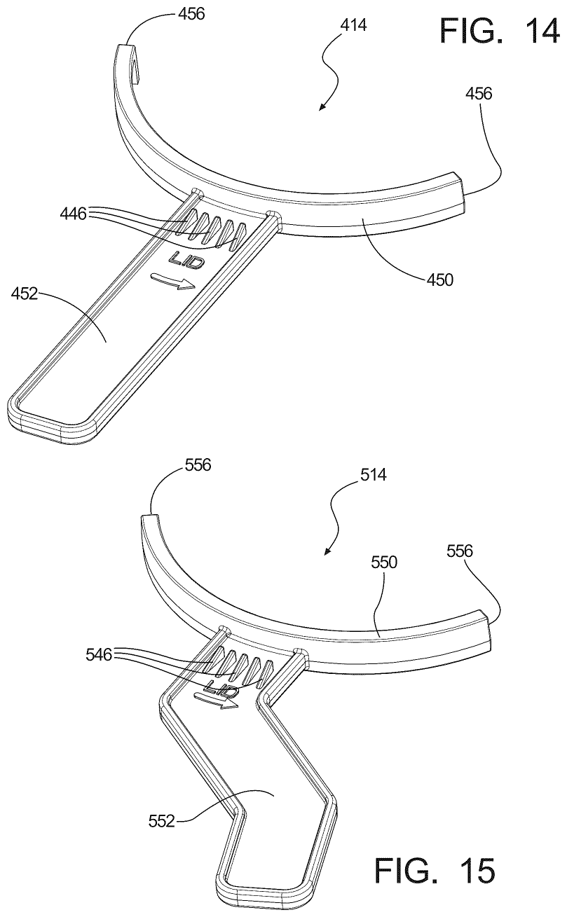

FIG. 15 show another alternative embodiment of the secondary handle 514. In this embodiment, the secondary handle 514 is generally identical to secondary handle 414, except that the arm portion 552 has a different shape. As shown, the arm portion 552 includes a plurality of linear segments that extend at different angles to one another. The gives the arm portion 552 an offset end segment that may facilitate operation of the wrench assembly 510 in some applications. Except as expressly shown or described, secondary handle 514 is generally identical to secondary handle 14 and FIG. 15 includes reference numbers that correlate with those used for secondary handle 14, except that they are preceded by a “5” (e.g. secondary handle 514 instead of 14 and jaw portion 550 instead of 50).

It will be appreciated that by identifying or naming herein certain elements as first, second, third, etc., that does not require that there always be a certain number of elements preceding, succeeding, above, below, adjacent and/or near the numbered elements. Further, any one of a numbered group of elements, for example, a third element, alternatively can be referred to as a first, second, fourth or other numbered row element. The same is true for the naming of any other elements in the form of a first element, second element, third element, etc. as used herein.

Although the different elements and assemblies of the embodiments are described herein as having certain functional characteristics, each element and/or its relation to other elements can be depicted or oriented in a variety of different aesthetic configurations, which support the ornamental and aesthetic aspects of the same. Simply because an apparatus, element or assembly of one or more of the elements is described herein as having a function does not mean its orientation, layout or configuration is not purely aesthetic and ornamental in nature.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

What is claimed is:

1. A wrench assembly for servicing a containment vessel of a water treatment system, comprising:
a primary handle having a jaw portion and an arm portion, the primary handle jaw portion having one or more mating features configured to mechanically interfit with one or more engagement features on a main body of a containment vessel, the primary handle further including a guide portion; and
a secondary handle interfitted with the guide portion of the primary handle, the secondary handle having a jaw portion and an arm portion, the secondary handle jaw portion having one or more mating features configured to mechanically interfit with one or more engagement features on a closure of a containment vessel.

2. The wrench assembly of claim 1 wherein the jaw portion of the primary handle is generally ring-shaped and includes an inner peripheral lip, and wherein the one or more mating features of the jaw portion of the primary handle are further defined as at least one notch defined by the inner peripheral lip.

3. The wrench assembly of claim 2 wherein the one or more mating features of the jaw portion of the primary handle are further defined as a plurality notches defined by the inner peripheral lip and arranged in a radially symmetric pattern.

4. The wrench assembly of claim 3 wherein each of the plurality of notches is an inwardly opening notch configured to fit over a radially projecting rib on a containment vessel.

5. The wrench assembly of claim 4 wherein the one or more mating features of the jaw portion of the secondary handle is further defined as a at least one notch, the notch being an inwardly opening notch configured to fit over a radially projection rib on a containment vessel.

6. The wrench assembly of claim 1 wherein the guide portion defines an elongated slot; and
wherein the secondary handle extends through the slot, the slot defining a range of motion of the secondary handle relative to the primary handle.

7. The wrench assembly of claim 6 wherein the jaw portion of the primary handle includes a shoulder, the shoulder defining the elongated slot.

8. The wrench assembly of claim 1 wherein the one or more mating features of the primary handle are disposed radially inwardly from the one or more mating features of the secondary handle.

9. The wrench assembly of 1 wherein the guide portion defines an elongated slot; and
wherein the secondary handle extends through the slot, the slot defining a range of motion of the secondary handle relative to the primary handle; and
wherein the secondary handle and the primary handle include snap-fit feature that secure the secondary handle in place within the slot while still permitting travel of the secondary handle along the slot.

10. A containment vessel and wrench assembly combination, comprising:
the containment vessel having a main body and a closure, the closure being rotationally fitted to the main body, the body including one or more engagement features, the closure including one or more engagement features;
the wrench assembly including:
a primary handle having a jaw portion and an arm portion, the primary handle jaw portion having one or more mating features configured to mechanically interfit with the one or more engagement features on a main body of a containment vessel, the primary handle further including a guide portion; and
a secondary handle interfitted with the guide portion of the primary handle, the secondary handle having a jaw portion and an arm portion, the secondary handle jaw portion having one or more mating features configured to mechanically interfit with the one or more engagement features on a closure of a containment vessel.

11. The combination of claim 10 wherein the jaw portion of the primary handle is generally ring-shaped and includes an inner peripheral lip.

12. The combination of claim 11 wherein the one or more mating features of the jaw portion of the primary handle are further defined as at least one notch defined by the inner peripheral lip.

13. The combination of 11 wherein the one or more mating features of the jaw portion of the primary handle are further defined as a plurality notches defined by the inner peripheral lip, the plurality of notches being arranged in a radially symmetric pattern.

14. The combination of claim 13 wherein the one or more engagement features of the main body include a plurality of radially projecting ribs.

15. The combination of claim 14 wherein each of the plurality of notches is an inwardly opening notch configured to fit over a corresponding one of the radially projecting ribs on the main body.

16. The combination of claim 15 wherein the one or more engagement features of the closure include a radially projecting rib.

17. The combination of claim 16 wherein the one or more mating features of the jaw portion of the secondary handle is further defined as at least one notch, the notch being an inwardly opening notch configured to fit over the radially projection rib on the closure.

18. The combination of claim 11 wherein the guide portion defines an elongated slot; and
wherein the secondary handle extends through the slot, the slot defining a range of motion of the secondary handle relative to the primary handle.

19. The combination of claim 18 wherein the jaw portion of the primary handle includes a shoulder, the shoulder defining the elongated slot.

20. The combination of claim 19 wherein the radially projecting ribs of the main body have a smaller outer diameter than the projecting rib of the closure.

21. The combination of claim 11 wherein the guide portion defines an elongated slot; and
wherein the secondary handle extends through the slot, the slot defining a range of motion of the secondary handle relative to the primary handle; and
wherein the secondary handle and the primary handle include snap-fit features that secure the secondary handle in place within the slot while still permitting travel of the secondary handle along the slot.
